(19) United States
(12) Patent Application Publication
(10) Pub. No.: US 2013/0151439 A1
(43) Pub. Date: Jun. 13, 2013

(54) Systems and Methods for Automated, User-Specific, Location-Based, Comprehensive Tax Burden Calculation, Analysis, and Display from a Personal Financial Profile

(71) Applicant: Daniel O. Galaska, Royersford, PA (US)

(72) Inventor: Daniel O. Galaska, Royersford, PA (US)

(21) Appl. No.: 13/313,448

(22) Filed: Dec. 7, 2011

(51) Int. Cl. G06Q 40/00

(52) U.S. Cl. 705/36 T

(57) ABSTRACT

An interactive query-based system provides user-specific, location-based, comprehensive tax burdens, based upon a taxable entity financial profile, for all locations in any user-designated geographical region. The system rank-orders the results of the user's query, and displays the data in a tabular format and/or geospatially in the form of a “heat map”, thereby allowing the user to quickly and easily determine a comprehensive tax burden for any location in the user-designated geographical region. Furthermore, because the results are rank-ordered, the user can easily compare the comprehensive tax burden for one location to any other number of locations, thereby enabling the user to quickly determine the location providing the lowest comprehensive tax burden, the location providing the highest comprehensive tax burden, and the order and value of those locations in between.

### BACKGROUND OF THE INVENTION

1. Field of the Invention

The invention pertains to the field of finance. More particularly, the invention pertains to systems and methods for calculation of a taxable entity's total tax burden for a given location or region of interest.

2. Description of Related Art

A person, family, or company contemplating a move faces a daunting challenge should they wish to determine locations to which they might move that would minimize their personal comprehensive tax burden (CTB). The lack of availability of user-specific CTB information to users hampers their understanding of the financial impact of the move from a tax perspective, inhibits their ability to do comparative analysis of their personal CTBs for different locations, and results in a limited ability to make a financially-prudent relocation decision from a tax perspective.

Currently, to get CTB data for a given location, users must first find what taxing authorities have jurisdiction in the given location. Then, they must spend time searching a plethora of websites or make telephone calls to all relevant taxing authorities to understand the different types of taxes they would have to pay, given their financial situation and role as a consumer. Once the tax types have been identified, they must then attempt to understand how the taxes would apply to their own personal financial situation. Armed with this information, they could then calculate their personal CTB—for a single location. Should they wish to do a comparative analysis with other locations, they must follow the same process all over again for each location of interest. This current method is so cumbersome and time-consuming as to make it virtually impossible for anyone to find their personal CTBs and do comparative analysis. As a result, today's reality is that those relocating to a new location have only a limited idea of the financial impact taxes will have on them at their new location—until they get to their new location and find out for themselves. Furthermore, they are unable to “shop” and do comparative analysis for the locations that would minimize their CTB.

The emergence of the internet has seen a wealth of tax information migrate to the internet. One can fairly easily find websites that contain most tax rates for common taxes, average taxes for average wage earners, and perhaps even a ranking of locations based upon a particular tax. Users, however, are left with little useable information for easily determining their specific comprehensive tax burden for any particular location. What is missing is the ability for users to easily determine their total or comprehensive tax burden for a particular location. There is no central website or database to find every tax one must pay when living in a particular location, or the user-specific cost of each of those taxes. Furthermore, there exists no central website or database where users can do comparative analyses of their specific CTBs for different locations.

### SUMMARY OF THE INVENTION

An interactive query-based system provides user-specific, location-based, comprehensive tax burdens, based upon a taxable entity financial profile, for all locations in any user-designated geographical region. The system rank-orders the results of the user's query, and displays the data in a tabular format and/or geospatially in the form of a “heat map”, thereby allowing the user to quickly and easily determine a comprehensive tax burden for any location in the user-designated geographical region. Furthermore, because the results are rank-ordered, the user can easily compare the comprehensive tax burden for one location to any other number of locations, thereby enabling the user to quickly determine the location providing the lowest comprehensive tax burden, the location providing the highest comprehensive tax burden, and the order and value of those locations in between.

### BRIEF DESCRIPTION OF THE DRAWINGS

FIG. 1 shows the functional architecture of a tax burden calculation system in an embodiment of the present invention.

FIG. 2 shows a user interface for geospatially selecting a region of interest in an embodiment of the present invention.

FIG. 3 shows a user interface for presenting the taxable entity's comprehensive tax burdens in the form of a heat map in an embodiment of the present invention.

FIG. 4 shows a magnified view of the map of FIG. 3 with color-coded and numerical comprehensive tax burdens and a user-selected breakdown of taxes in a selected area in an embodiment of the present invention.

FIG. 5 shows an alternative user interface for presenting the taxable entity's comprehensive tax burdens in the form of a table in an embodiment of the present invention.

FIG. 6 shows system architecture in an embodiment of the present invention.

### DETAILED DESCRIPTION OF THE INVENTION

Interactive query-based systems and methods provide user-specific, location-based, comprehensive tax burden (CTB) calculations and analysis for any and all locations in a user-specified geographical region. CTB is defined as the sum total of all taxes from all taxing authorities a user would pay if they were to live in a particular location, that is, any tax defined by taxing authorities, including, but not limited to, income tax, real estate tax, property tax, and sales tax, at any level, including, but not limited to, local, county, school district, state, and federal. In some embodiments, systems and methods of the present invention allow users to educate themselves about their specific CTB for any geographical region covered by the tax database and to do comparative analysis with CTB values from any number of other locations, thereby enabling them to make a more financially prudent relocation decision.

In its simplest embodiment, the systems and methods allow the user to ask for a customized CTB calculation for a single location by entering an address. After making the appropriate tax calculations, the system displays, in text format, the user's CTB value as well as the taxes and associated amounts that comprise the CTB value for that location. In a more complex embodiment, the user can ask for CTB data for multiple locations. This allows the system to provide not only CTB values for multiple locations, but ranking analysis of those values as well. In essence, it provides value-add to the CTB data itself. Preferably, the system provides this ranking analysis in the form of a heat map, but the rankings may alternatively be displayed in tabular/text format as well.

In order for the system to customize or “personalize” user-specific comprehensive tax burdens for any number of locations and provide the results to a user, it must have four components:

1) An understanding of the user's income, property ownership, and taxable spending habits—all of which result in a variety of taxes paid to a variety of taxing authorities ranging from the Federal Government to local level government.

2) Appropriate tax formulas of all taxing authorities having taxing jurisdiction at a particular location.

3) Calculation of the user's comprehensive tax burden for a user selected location, based upon the information in number 1 and 2 above.

4) Display of the user's calculated tax burdens in a manner that is quickly and easily interpreted.

A taxable entity as used herein refers to any individual taxable unit as considered by any taxing authority, including, but not limited to, an individual, an individual and one or more of his or her dependents, a married couple, a married couple and their dependents, and a business.

A user as used herein refers to any individual using the systems and methods of the present invention. In some embodiments, the user is the taxable entity or part of the taxable entity. In other embodiments, the user may be a third party, who is neither the taxable entity nor part of the taxable entity.

Embodiments of the present invention overcome the limitations of existing tax data presentation by providing an interactive system with personalized data via the internet or software, which displays a customized personal CTB display for any regions or locations selected by the user. The system may display the results of the user's query not only in a tabular format, but geospatially as well, in the format of a “heat map” that allows the user to quickly identify and differentiate relatively expensive taxing jurisdictions from relatively inexpensive taxing jurisdictions, all in geographical areas of their choosing. Users see the locations that give them the highest CTBs and those that give them the lowest CTBs, and the dollar differences. Having this information available allows users to determine their actual tax dollar cost of living in one locale versus another, thereby providing a substantially complete financial picture from a tax burden perspective of living in one location versus another.

In order to receive taxable entity-specific results, users populate a taxable entity financial profile with details about the type and amount of taxable income and assets of the taxable entity. In some embodiments, the financial profile is a personal financial profile (PFP) for an individual or a family. The PFP is used by the system for calculating the taxable entity's different taxes. Data for the PFP may vary depending on whether the taxable entity is an individual, a family, or a business. Data for the PFP may also vary depending on whether the individual or family is moving for retirement relocation purposes or for job relocation purposes. Data for the PFP may include, but is not limited to, income types, income amounts, property owned, value of property owned, consumer spending habits and amounts, job location, retirement assets, and age.

Upon the user's completion of a PFP, the user can make a selection by designating a regional area or individual locations for which CTB values are desired. A tax engine makes CTB calculations for the designated areas using an internal tax database and the user's PFP. The tax engine computes the user's estimated total tax for each location in the specified region as if the user were living in each one of those locations. Once the CTB calculations have been computed, they preferably are rank-ordered, stored in a CTB database, and displayed back to the user in a geospatial format, in a tabular format, or both a geospatial and a tabular format. The user is then free to conduct in-depth analysis of their results using supporting calculations and displays provided by the system. In this manner, users are able to quickly assess their total tax in any number of locations and do comparative analysis against any number of locations.

In another embodiment of the invention, a profile is made available for companies, along with a tax database particular to business operations. In this manner, those businesses, preferably those starting small businesses, are able to determine CTB values for their business, thereby enabling comparative analysis for locating the business in a manner that would be advantageous from a tax perspective.

### Functional Overview

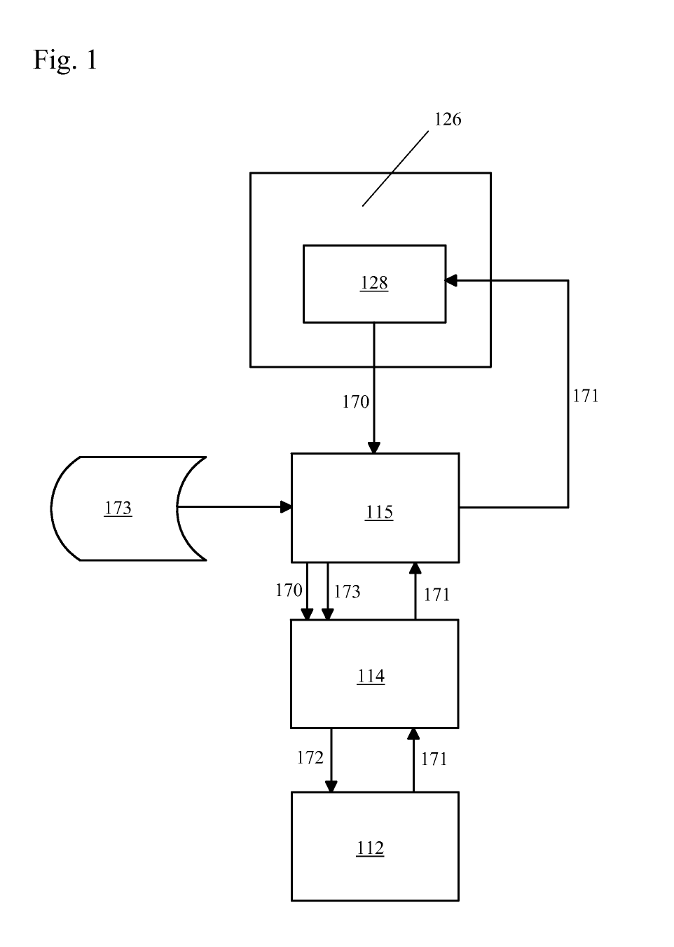

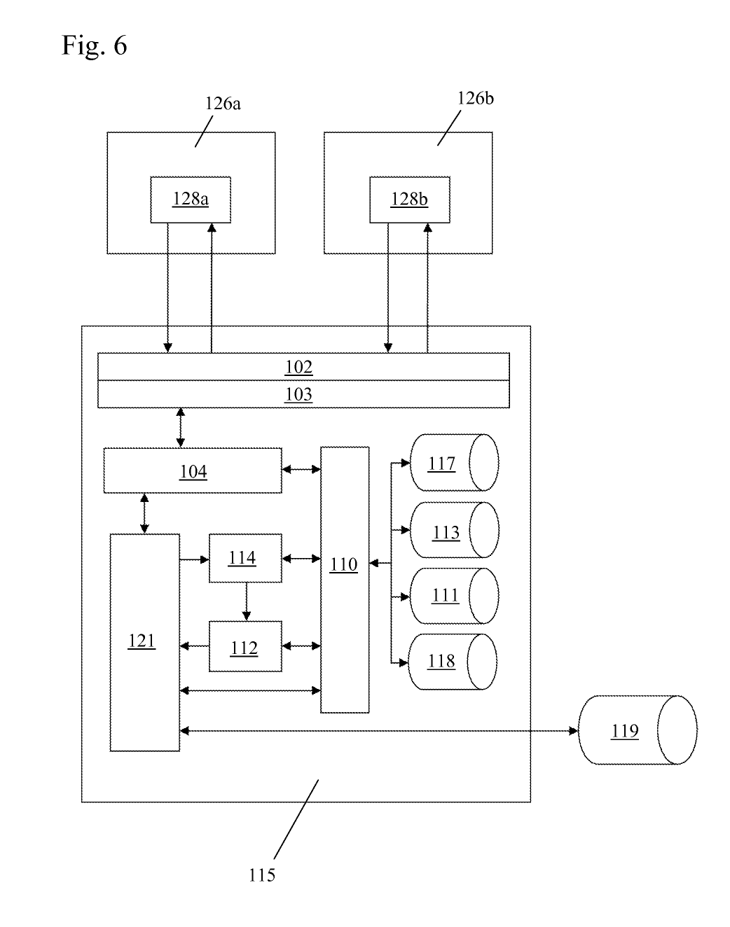

Turning to FIGS. 1 and 6, a functional overview of the operation of one embodiment of the present invention is shown, which provides to a user their personal comprehensive tax burdens for any number of locations in one or more user-selected regions. The user operates an electronic device 126, which may be a computer 126a or a mobile device 126b using a user interface 128. The mobile device 126b may be any mobile device which is capable of accessing the internet. In some embodiments, the mobile device 126b is a cellular telephone. In other embodiments, the mobile device 126b is a tablet device with internet access. The user interface is preferably a conventional Web browser providing access to the internet and the World Wide Web. The user connects over the Web to the system website for access to the online total tax system 115.

To gain access to comprehensive tax data, a user personal financial profile (PFP) 173 is first created and maintained by each user for use by the system. The personal financial profile 173 contains details of the taxable entity's taxable items. The system queries the user with specific questions relative to the taxable entity's financial situation and consumer spending habits. This data is prompted by queries and manually entered by the user; however a limited amount of data may be imported from other applications or databases. The personal financial profiles 173 are securely stored either remotely or on the electronic device.

Once a user has populated and stored a personal financial profile 173, the system offers the user the option to select one or more specific locations of interest, or one or more general regions of interest via a number of different methods. For a specific location of interest, the system preferably provides at least three methods for the user to specify the location. One method is via a standard interactive geographical map similar to those commonly found on the internet today. The geographical map is preferably divided into selectable tax areas, each tax area being defined as having the same set of applicable tax laws within the tax area. The user may select a specific location simply with a mouse click. Another method is for the system to prompt the user to enter an address of the desired location. Yet another method is for the system to receive the user's current GPS coordinates automatically from a GPS-enabled device.

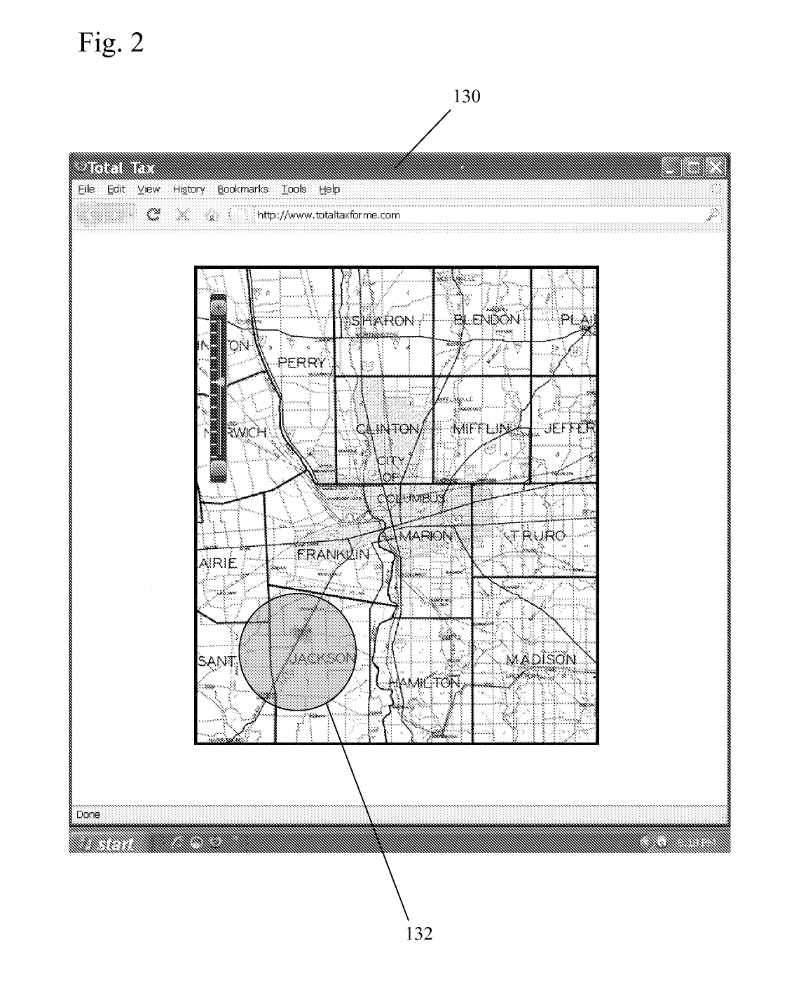

Correspondingly, there are preferably at least four methods for the user to specify a region of interest. One method is to prompt the user to enter the region, such as a county or state. Another method is for the user to select from a drop-down list of taxing authorities, either at the county level or state level. Yet another method is via geospatial display, where the user interactively selects the region of interest via mouse clicks on the geospatial display, each mouse click adding a tax area, city, county, or state to the region of interest. Another method is via geospatial display, where the user interactively selects the region of interest via mouse click-and-drag, enabling the region to be defined as a circle with its center at the location of the mouse click with a radius defined by the extent to which the mouse is “dragged” or alternatively as a rectangle defined by the “dragged” area. FIG. 2 shows a window 130 of a user interface in which a user has selected a region of interest 132 via a circle.

No matter which of these methods is selected, whether for specific locations or regions, the tax query 170 is transmitted from the user's browser to the online comprehensive tax system 115, and ultimately to the tax engine 114. The tax engine 114 uses a proprietary tax database 111 which is populated and maintained with tax data from a variety of public sources. The tax engine 114 uses this tax database 111 in conjunction with the PFP database for the user's personal financial profile 173 in order to make comprehensive tax burden 172 calculations.

The tax database 111 preferably stores a set of encoded rules, objects, or any other data structures that embody the current tax law requirements, rates, and tax computations for all required taxing authorities. The tax database 111 is preferably maintained and updated at a secure location remote from the electronic device 126. The tax database is preferably a proprietary database updated on a regular basis to reflect changes in tax laws and remain current with the tax laws. The tax database may be updated on a daily, weekly, monthly, or semi-annual basis. In some embodiments, the tax database is updated automatically by automatically checking websites for updated tax information and updating the database when the checked website is determined to have been updated. Based on the taxable entity's personal financial profile 173, and the locations or regions selected, the tax engine 114 executes the appropriate tax calculations and computes the taxable entity's comprehensive tax burden 172 for each of the lowest level taxing authorities that fall within the user's selection. For example, if a user made the regional selection of a county within Pennsylvania, that county including 60 townships and boroughs, then 60 separate comprehensive tax burden 172 calculations would be required for that region. Each comprehensive tax burden 172 calculation preferably includes taxes the user would have to pay at the township, school district, county, state, and any other governmental level, thus giving the user their total and complete tax liability should they decide to live in that particular township, given the data provided in their personal financial profile 173. Once the comprehensive tax burden 172 calculations have been made, they are stored in a comprehensive tax burden database 113 and sent to the analyzer 112 for rank-ordering of the data.

The tax engine 114 calculates a taxable entity's tax liability based upon all the data provided by the user. It takes information from the personal financial profile 173 and applies the tax rules and calculations as determined by each of the relevant taxing authorities. If the data in the personal financial profile 173 is changed, the taxable entity's comprehensive tax burdens 172 are recalculated. This allows the personal financial profile 173 to be updated to reflect additional information that would affect the user's potential tax liability.

After completing the comprehensive tax burden 172 calculations, the tax engine 114 preferably forwards the data to the analyzer 112 for automated analysis of the data. The analyzer 112 preferably rank-orders the data and assigns color codes prior to sending the rank-ordered comprehensive tax burden 171 data to the display engine 121 for formatting and displaying of the results to the user.

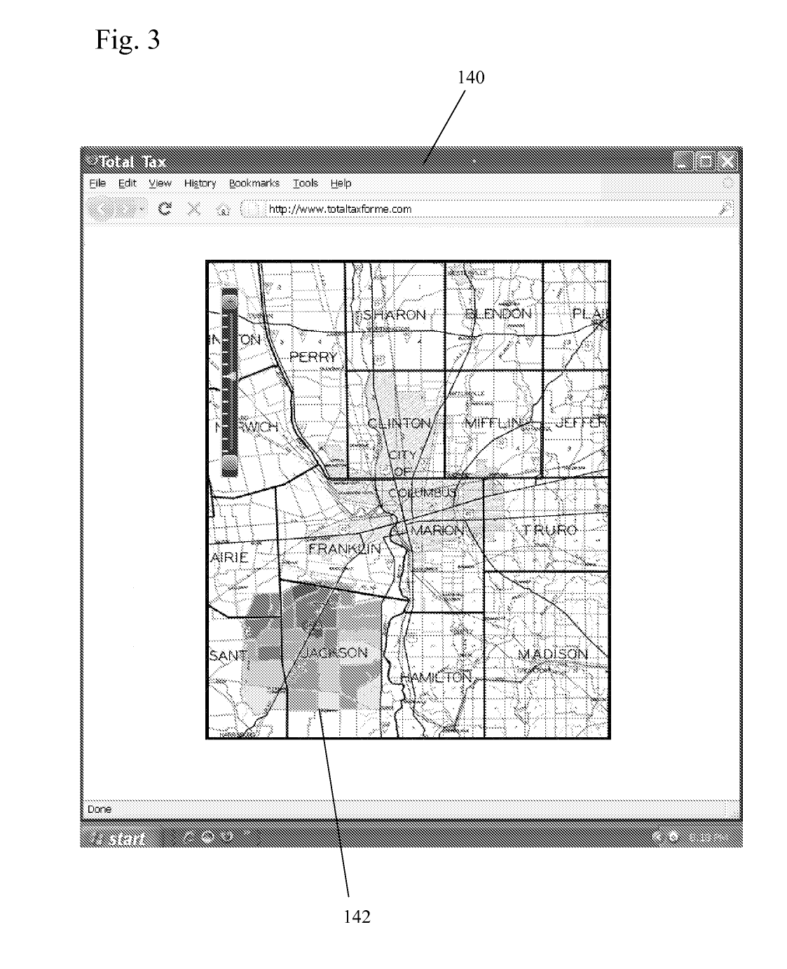

The display engine 121 preferably provides for viewing the rank-ordered comprehensive tax burden 171 data geospatially 142, as shown on the window 140 in FIG. 3, or in tabular format as desired by the user. Manipulation of the data by the user can then be done for greater analysis and custom views. Data displayed geospatially is preferably displayed in the form of a heat map, allowing the user to quickly see the locations that provide a relatively low comprehensive tax burden for the user, those locations that provide a relatively high comprehensive tax burden for the user, and those locations that fall in between.

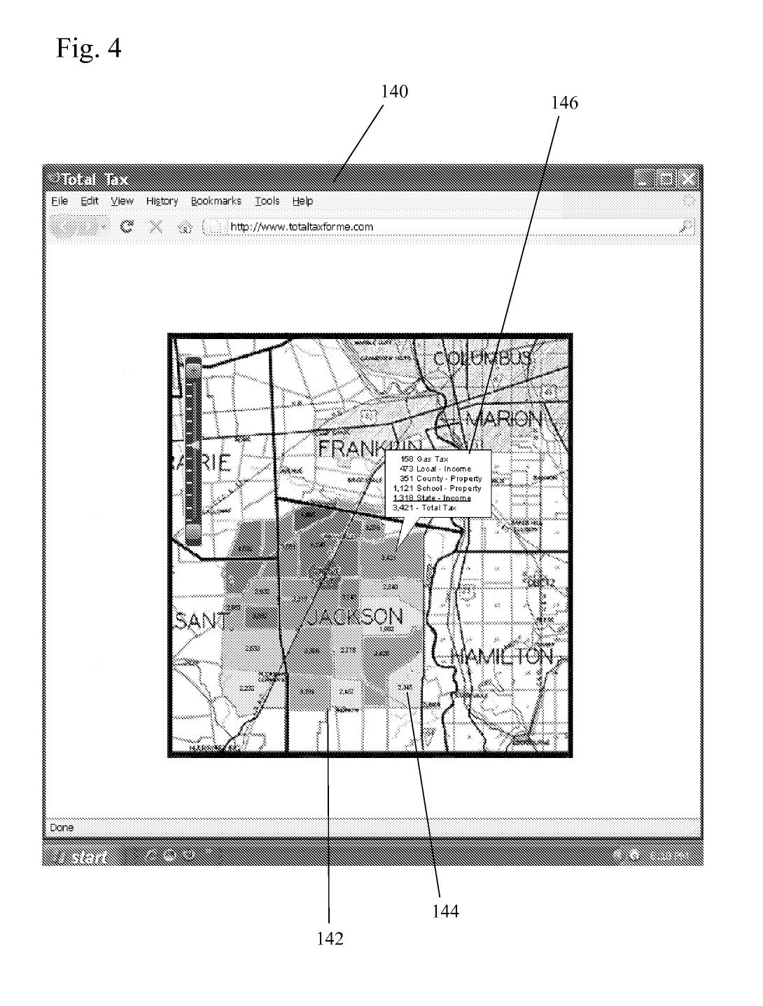

The geospatial display preferably offers the standard features found with online maps such as pan and zoom. Additionally, a tax jurisdiction overlay is preferably provided so the user can clearly see the geographical boundaries of taxing authorities, and therefore the geographical boundaries for which comprehensive tax burden value would apply—even down to the street level should the user choose to zoom in to a street level view. The geographical area of each taxing authority for which a rank-ordered comprehensive tax burden 171 has been calculated is preferably shaded with a transparent color corresponding to the color assigned by the analyzer 112. As the user zooms in to a system-defined extent, in addition to the assigned colors being displayed for each taxing jurisdiction, the comprehensive tax burden values are preferably centrally displayed 144 within each taxing jurisdiction as shown in FIG. 4. The user selection of a rank-ordered comprehensive tax burden 171 value via a mouse click preferably causes the system to display 146 the specific taxes including that value and their associated amounts as shown in FIG. 4.

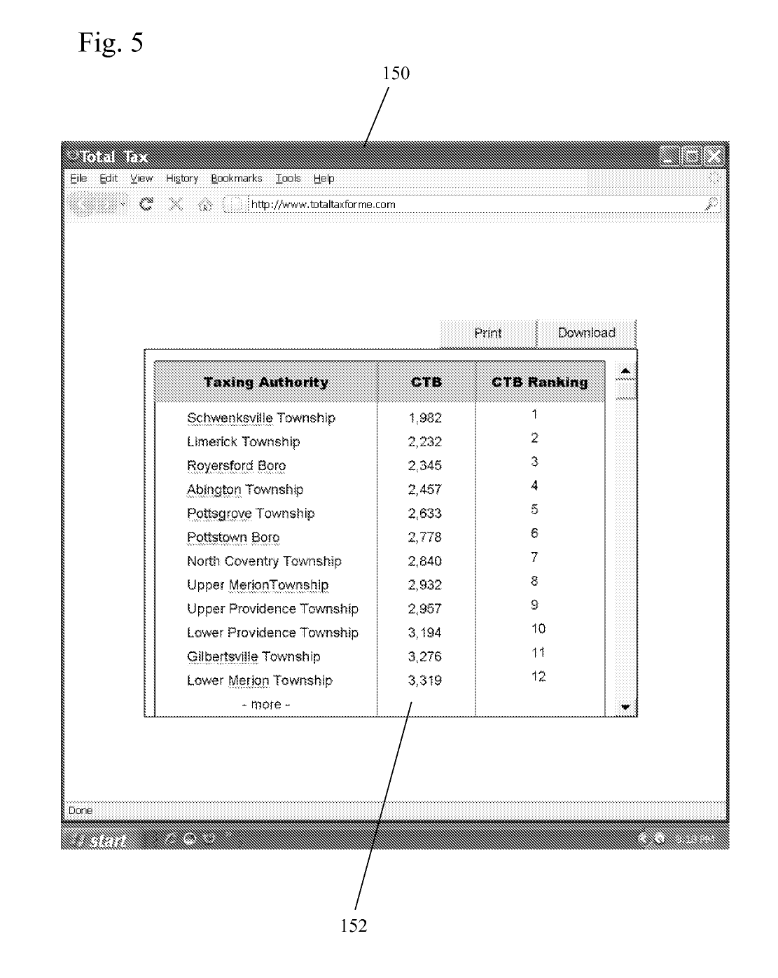

Should the user prefer a tabular display, the system displays the data on the window 150 in a user-sortable tabular format 152, as shown in FIG. 5, preferably allowing the user to sort by taxing authority, comprehensive tax burden value, and comprehensive tax burden ranking. In some embodiments, other or additional fields and sorting options may be available. As with the geospatial display, user selection of a specific comprehensive tax burden value via mouse click causes the system to display the specific taxes comprising that value and their associated amounts. Selection of the taxing authority displays a map that allows the user to see the geographical location of the taxing authority represented by that value. The user is preferably able to download and print these results.

Preferably, the user may choose at any time a new region or location of interest, thereby causing the system to re-calculate, re-analyze, and display the new data based upon the user's new selection.

### System Architecture

Referring back to FIG. 1 and FIG. 6, FIG. 6 shows a schematic illustration of the system architecture of one embodiment of a system of the present invention. Those skilled in the art will recognize that the illustration of FIG. 6 is schematic and for clarity omits many of the conventional components present in an online system, including, but not limited to, mechanisms for security, fault tolerance, billing, directory services, monitoring, and administration. This is done so as to focus on those features more pertinent to the description of the invention. The overall structure of the system is preferably that of an online personal comprehensive tax burden tool accessible by users online via their computer or mobile device. The elements of this system are discussed with reference to FIG. 6.

An account management module 104 preferably acts as a gatekeeper to the system by providing secure user accounts and allowing access to different system features based upon those features licensed to each individual user. Preferably some information provided by the system is available to the general public, while other information is available to members only, such information being determined by system license parameters in the account management module 104 based upon the service the user signed up for. Account access is preferably controlled using conventional security mechanisms, including userIDs and passwords. The account management module 104 preferably interfaces with the Web server 102 via a user interface module 103 to receive input data, including, but not limited to, personal financial data and tax queries, from the user's computer 126a or mobile device 126b, via the respective user interface 128a, 128b.

In addition to support for conventional features, the account management module 104 controls access to a taxable entity's personal financial profile 173. The personal financial profile 173 contains information specific to each user required for use in tax calculations, and must be completed by the user prior to accessing the system for comprehensive tax burden calculations. This information includes, but is not limited to, income sources and amounts, amounts spent yearly in various consumer spending categories, property ownership and market value of such property, and other categories considered taxable by taxing authorities. A user may maintain multiple profiles in instances where commercial applications make it necessary, such as realtors. Once a personal financial profile 173 is established, the account management module 104 preferably also allows the user to view, edit, and update their profile at any time as long as the license agreement remains in effect.

The personal financial profile 173 is preferably stored in a personal financial profile database 117 that allows it to be easily accessed by the system for making the taxable entity's comprehensive tax burden calculations. The personal financial profile database 117 preferably includes the normal security infrastructure required for the handling of confidential information.

The account management module 104 preferably interfaces with the Web server 102 via the user interface module 103 to receive the user's profile information data or interactive queries from the user's browser, whether from a computer 126a or mobile device 126b.

The user interface module 103 provides the presentation layer to allow the user to interact with the system. The user interface module 103 is preferably responsible for constructing the graphical presentation provided to the client's browser and for receiving and processing data and commands from the browser to provide to the account management module 104. The user interface module 103 preferably provides pages or windows to the Web server using one or a combination of technologies, including, but not limited to, hypertext markup language (HTML), dynamic hypertext markup language (DHTML), extensible markup language (XML), Java, JavaScript, JavaServer pages (JSP), and active server pages (ASP).

In addition to support for conventional account management features, the account management module 104 preferably interfaces with the display engine 121. The display engine 121 preferably formats the geospatial visual representations for the user interface module 103 to allow the user to make comprehensive tax burden queries, as well as to view the resulting rank-ordered comprehensive tax burden data 171. The display engine 121 preferably primarily uses geospatial displays, but may present selection options and data in tabular formats. In order for the user to make comprehensive tax burden requests geospatially, the display engine 121 preferably accesses the Geographical Information System (GIS) database 118 and map servers 119 available via the internet. The GIS database 118 preferably stores jurisdictional boundary layers for taxing authorities which are overlaid on the geospatial data received from internet map servers 119. This allows users to clearly see the geographical area for which each comprehensive tax burden will be applicable.

Upon user selection of locations or regions of interest, the display engine 121 preferably forwards the user requests to the tax engine 114. The tax engine 114 is preferably a computational engine that interfaces with the personal financial profile database 117, the tax database 111, and the comprehensive tax burden database 113 through a database management system 110. In conjunction with the user-selected locations or regions of interest, the tax engine preferably retrieves relevant data from the personal financial profile database 117 and tax database 111, applies the applicable tax rules, and computes the comprehensive tax burdens. These comprehensive tax burden calculations and the individual taxes and tax amounts are preferably then written to the comprehensive tax burden database 113, and the comprehensive tax burdens 172 are sent to the analyzer 112 for ranking analysis and then to the display engine 121 in preparation for display to the user in a geospatial or tabular format.

The analyzer module 112 preferably receives the comprehensive tax burdens 172 from the tax engine 114, rank-orders the data, and assigns a color to each comprehensive tax burden value. The colors assigned are determined as follows:

The analyzer 112 preferably determines the range between the highest and the lowest comprehensive tax burden values, this range then being divided into any number of equal sub-ranges, such as 10 sub-ranges, thereby creating a sub-range for those comprehensive tax burden values that fall within the lowest sub-range, such as the lowest 10% of the range between the highest and lowest values, the next highest sub-range, and so on, up to those that fall within the top sub-range, such as the highest 10% of the range between the highest and lowest values. The system preferably assigns a unique color to each sub-range such that, any comprehensive tax burden values falling within the lowest sub-range is assigned color 1, those falling within the next highest sub-range is assigned color 2, and so on until a unique color has been assigned to all values in all sub-ranges.

The analyzer 112 preferably then stores the color values, along with the corresponding ranking values, in the comprehensive tax burden database 113, and forwards the rank-ordered comprehensive tax burden 171 data, which may include, but is not limited to, the values, the rankings, and the corresponding colors, to the display engine 121.

The comprehensive tax burden database 113 is preferably used by the tax engine 114 to store newly-calculated comprehensive tax burden values, or to retrieve rank-ordered comprehensive tax burden data 171, which may include, but is not limited to, taxing authority names, their corresponding comprehensive tax burden values, rankings, and color assignments, calculated previously and needed for redisplay. Additionally, the comprehensive tax burden database 113 is preferably used by the analyzer module 112 to store newly rank-ordered comprehensive tax burden 171 data, which may include, but is not limited to, taxing authority names, their corresponding comprehensive tax burden values, rankings, and color assignments.

The display engine 121 preferably prepares the data for display prior to sending it to the user interface module 103 in one of at least two methods. One method is to display the data in a geospatial manner, and includes the following:

The display engine 121 calls geospatial data from internet map servers 119 if the proper maps are not currently displayed on the user's interface.

The display engine 121 accesses the GIS database 118 for the appropriate jurisdictional boundary layer for taxing authorities and overlays the layer on the map from the internet map servers 119.

For each comprehensive tax burden value, the display engine 121 shades the geographic area corresponding to that comprehensive tax burden value with the color assigned by the analyzer 112, and assigns the comprehensive tax burden value to that geographic area.

In this manner, the comprehensive tax burden data is displayed geospatially, and the user is able to use normal geospatial tools such as pan and zoom to view the results. Additionally, by way of the user clicking on a comprehensive tax burden value, the system calls the components, including the comprehensive tax burden value from the comprehensive tax burden database 113, and returns them to the user. The user is then able to view the different taxes that make up the comprehensive tax burden value and their associated amounts.

Another method is to display the data in a tabular format and includes the following:

The display engine 121 receives all of the rank-ordered comprehensive tax burden data 171 from the analyzer 112, which may include, but is not limited to, taxing authority names, their corresponding comprehensive tax burden values, rankings, and color assignments, and sends them to the user interface module 103 for display in a user-sortable tabular format.

The following preferred embodiment is provided for illustrative purposes only, as many variations are possible within the spirit of the present invention.

### Personal Financial Profile

To access the system, the user must first accept a license agreement and create a standard user account with a userID/password and submit any required payment information via a standard ecommerce application on the system website. This then allows the user to create a Personal Financial Profile (PFP). The PFP is simply a data profile used to capture the user's current address, taxable income sources and amounts, taxable spending habits, property ownership, and any other relevant data required by taxing authorities for tax calculations. User PFPs are stored in the PFP database for later use by the system in making user-specific comprehensive tax burden calculations.

A user's PFP is created by the system through a series of responses to queries presented by the system to the user. The queries presented are dictated and created during the creation and/or maintenance of the tax database. As the user responds or makes a selection for each question, the user's response is stored in their PFP, and the system presents the next query to the user based upon their response to the previous query. This process continues until all appropriate queries have been presented to the user. A user may choose to answer the queries presented to him, or not. However, the more accurate and complete the answers provided by the user are, the more accurate the comprehensive tax burdens calculated by the system and presented to the user will be.

For the purposes of this illustration, taxes can generally be divided into three categories, and therefore the PFP queries are divided to gather three types of taxable data from the user: 1) Income, 2) Expenses, and 3) Property Ownership. For any query presented, the user can enter actual current data, “what if” data, or expected future data, such as an expected increase in salary or the expected purchase of a new home. Examples of these queries are presented in the following sections of this document. These queries are presented in logical progression for the user to either answer or skip as they feel is relevant to their particular situation. The answers to these queries comprise the user's PFP, and are stored in the PFP database for later use in tax calculations specific to that user.

### Income

In the taxable category of Income, PFP queries are directed to gather information regarding the user's income sources and associated amounts as defined by the different taxing authorities. Any conventional methodology may be used. For example, Intuit's TurboTax® software uses this methodology to assist users in completing Federal and State tax returns. The user's responses to queries are used by TurboTax® software to create a customized tax return for the user. In a like manner, the systems and methods capture user responses to queries to create customized comprehensive tax burden calculation results. Following is a subset of queries that may be presented to a taxable entity. In addition to this sample set of queries, sample data that is representative of a nominal American household is provided for this illustration. For purposes of this illustration, the following nominal data has been assumed:

Family: Includes husband and wife, both are wage earners earning a total of $70,000/yr, residing in Limerick, Pa.
Includes two children less than 18 yrs old.

Property: Includes a single family home valued at $200,000, one car, and one SUV.

The following are a subset of income queries designed to capture the specifics of a user's income sources and amounts:

Enter TOTAL INCOME (includes wages, tips, interest, dividends, etc. Do not include alimony, child support, social security, unemployment compensation.)

(Because the following income sources are taxed by some taxing authorities and not by others, these queries are presented in order to determine what, if any, amounts should be excluded from certain income tax calculations.)

Enter FEDERAL ACTIVE-DUTY PAY

Enter ALIMONY

Enter CHILD SUPPORT

Enter INHERITANCE

Enter SOCIAL SECURITY

Enter PUBLIC ASSISTANCE

Enter UNEMPLOYMENT COMPENSATION

Enter DISTRIBUTIONS FROM RETIREMENT PLANS

RETIRED? Enter YES or NO

Enter INTEREST

Enter DIVIDENDS

Based on the data from the sample family above, the only query this user would respond to is the first one for TOTAL INCOME, to which the response would be $70,000. This data is retained in the user's PFP by the system.

### Expenses

In the taxable category of Expenses, PFP queries are directed to gather information regarding the user's taxable consumer spending habits. As with income, different categories of consumer products are excluded from taxation depending upon the taxing authority. Normal and/or expected spending habits on a variety of categories of consumer products are therefore identified. Consumer products are normally taxed at the State level, so a user will generally not see a difference in consumer taxes unless comparing locations in different States. A non-exhaustive list of consumer product categories, and therefore queries needed, includes food purchases, dining out, gasoline consumption, tobacco products, clothing, and general consumer purchases. As is the case with income sources, the user is prompted to identify monthly or yearly totals for each category of consumer product.

The following are a subset of consumer product queries designed to capture the specifics of a user's taxable consumer spending habits:

Enter TOTAL CONSUMABLE PURCHASES (includes groceries, retail, hardware, dining out, etc.)

Enter CARTONS OF CIGARETTES PURCHASED

Enter GALLONS OF GAS PURCHASED

Enter GALLONS OF DIESEL FUEL PURCHASED

Enter CLOTHING/SHOE PURCHASES

Enter GROCERY PURCHASES

Enter MEDICAL SUPPLY PURCHASES

Enter PRESCRIPTION/NONPRESCRIPTION MEDICINE PURCHASES

Enter PRESCRIPTION EYEGLASS/CONTACT LENSE PURCHASES

Enter COAL, FUEL OIL, GAS, FIREWOOD PURCHASES

For simplicity of illustration, the sample family introduced above is not concerned with local differences in any of these listed expenses, so the user enters no expense data in this case.

### Property Ownership

In the category of Property Ownership, PFP queries are directed to gather information regarding the user's taxable property. As with income and expenses, some property is excluded from taxation depending upon the taxing authority. Types of property owned and associated values must therefore be identified. A non-exhaustive list of potentially taxable property, and therefore queries needed, includes homes, motor vehicles, recreational vehicles (RVs), and boats. As with the income and expense categories, the user is prompted to identify the type and value of each relevant piece of property owned, as taxes of this nature are generally calculated based upon the value of the property.

Following is an example of a subset of property ownership queries designed to capture the specifics of a user's property:

Enter MARKET VALUE or ASSESSED VALUE and LOCATION of home (if one is owned)

Enter MARKET VALUE or ASSESSED VALUE and LOCATION of any other real estate owned

Enter MARKET VALUE and MAKE/MODEL/YEAR of each car owned

Enter MARKET VALUE and MAKE/MODEL/YEAR of each SUV/Truck owned

Enter MARKET VALUE and MAKE/MODEL/YEAR of each boat owned

For the sample family, when queried about the MARKET VALUE of home, the user responds by entering $200,000. This data is retained in the user's PFP by the system.

These three categories of taxable information comprise the sum of the PFP. User responses are stored in the PFP database for later access by the Tax Engine. The user can also review and make changes to their PFP at any time. Upon completion of the PFP, the user can move on to select locations, and/or regions for which they desire the system to provide comprehensive tax burdens.

### Tax Database

The tax database includes proprietary tax equations and tax rates gathered from the public domain, including governmental websites, pamphlets, and direct communication (telephone, email, correspondence). The database includes manually entered tax data and fees levied on consumers on a regular basis from taxing authorities at all levels of government in the areas of income, consumer, and property taxes. For each relevant tax within each taxing authority, the appropriate tax equation is created and the tax rate and tax type are stored in the tax database. Each tax calculation contains the conditions upon which the tax applies. During database creation, as each new tax is entered in the database, a corresponding PFP query must be created for later use during user PFP creation in order to capture whether or not that tax applies to a user. For example, there are many types of income sources, and each one is taxed or not taxed depending upon the taxing authority.

For instance, active duty military pay in Virginia is taxed at the state level, but active duty military pay in Pennsylvania is not taxed at the state level. A tax algorithm must therefore be generated and stored in the tax database in order to calculate or exclude, as the case may be, any tax associated with active duty military pay.

Since the CTB requires that taxes be calculated from all taxing authorities having jurisdiction at any specified location, the system must know what taxing authorities have jurisdiction at a specified location. This information is also stored in the tax database. That is, for each taxing authority at the local level (Local Taxing Authority—LTA), the database stores the names of the other taxing authorities who share jurisdiction and whose algorithms must be included in the CTB calculations for that local taxing authority. For example, any CTB calculation for Limerick, Pa. must include taxes for Limerick Township, Spring-Ford Area School District, Montgomery County, and Pennsylvania. In this manner, when a database lookup is done for Limerick, Pa., the Tax Database also provides the names of other taxing authorities whose tax algorithms must be used to provide a CTB.

The tax database is preferably updated manually on a semi-annual basis as new tax rates become available by taxing authorities.

### User Selection

The user is preferably able to query the system about their comprehensive tax burden for one or more areas of interest. The user may select either a specific location of interest, or a region of interest (including multiple contiguous locations) for which they desire CTBs.

For every geographical location, there is some combination of taxing authorities having taxing jurisdiction at that location, at the local level, school district, county level, state level, and federal level. If one considers a three dimensional view of taxing authorities, at the top layer with a geographical taxing jurisdiction covering the entire United States would be the Federal Government. Encompassed within the geographical taxing jurisdiction of the Federal Government is a sub-layer of 50 State taxing authorities—each with its own geographical taxing jurisdiction. State governments are referred to as “first-tier” taxing authorities. Encompassed within the geographical taxing jurisdiction of each State is a sub-layer of county taxing authorities—each with its own geographical taxing jurisdiction. Counties are herein referred to as “second-tier” taxing authorities. For some States such as New Mexico, the county is the lowest level taxing authority within the State. Such States are referred to as “second-tier” States. For other States such as Pennsylvania, the county is further divided into local municipal taxing authorities, or townships/boroughs—each with its own geographical taxing jurisdiction. Townships/boroughs are herein referred to as “third-tier” taxing authorities. States in which townships are the lowest level taxing authorities in the State are referred to as “third-tier” States. And, for some States, school districts are another layer of taxing authorities, each district having its own geographical taxing jurisdiction. Therefore, when a CTB calculation is made, it includes the tax calculations from each of the taxing authorities having taxing jurisdiction at that location, and includes generally the taxes on the user's income, expenses, and property.

This is important with respect to systems and methods of the present invention for the following reasons. A person paying State taxes pays the same State tax regardless of where they live in the State. State taxes paid are independent of a person's address, so long as the person lives in the State. The same is true at the county level. Given the same PFP, a person's county taxes will be the same regardless of where they live in the county. The same is also true at the township level—given the same PFP, a person's township taxes will be the same regardless of where they live in the township. It is therefore also true that a CTB value will be valid no matter where in the township (for third-tier States) or the county (for second-tier States) the person lives.

To pick a “specific location” from a user perspective implies the user selects a specific address for which they desire a CTB. However, from a system perspective the smallest geographical granularity of CTB values needed is at the township level for third-tier States, or at the county level for second-tier States. Therefore, from a system perspective, a location is a township for third-tier States, or a county for second-tier States. For this reason, when a user provides a specific address of interest, the system determines in what local taxing authority (LTA) the address is located, and the CTB value calculated for that user-specified address is applicable for any location in the LTA. The geographical area covered by an LTA is referred to herein as a geographic tax unit. For example, if the user were interested in a CTB value for 704 West Main Street, Trappe, Pa., the system determines (via the GIS database) that the location is in Limerick Township. The CTB value calculated is therefore applicable to any location in Limerick Township, if the user is renting a home/apartment, or if the PFP indicated home ownership, the CTB value calculated is applicable for any location in Limerick Township with a comparably priced home.

### Location Selection

One method for selection of a specific location is for the user to enter one or more specific address on a system-presented “fill-in” form. The system provides one CTB value to the user for each address entered. Addresses must include Street Number, Street Name, City, and State. When the addresses have been submitted by the user, the addresses are transmitted from the user's browser to the system's Tax Engine for CTB calculation. When the CTB calculations have been completed, they are returned to the user's system for display via the browser.

A second method for selection of a specific location is via a drop-down list. The drop-down list enables the user to select from a pre-populated list of townships, boroughs, or counties on a State-by-State basis. The user first selects the desired State from a drop-down list of States. For this illustration, assume that the user selects Pennsylvania. Since Pennsylvania is a third-tier State, this selection causes the system to display a drop-down list of all the boroughs and townships in Pennsylvania for the user to choose from. If the user had chosen New Mexico (a second-tier State) instead of Pennsylvania, the system would then display a drop-down list of all the counties in New Mexico because there are no boroughs or townships in the State of New Mexico. Once the selection has been made, the system then prompts the user if another location is desired. If so, the system guides the user through the same process. If not, the user's request is submitted to the Tax Engine for CTB calculation. When the CTB calculations have been completed, they are returned to the user's system for display via the browser.

A third method for selection of a specific location is for the system to receive the user's current latitude/longitude coordinates automatically from a GPS-enabled device simply by the user selecting the system option to “use current location”. This transmits the user's current coordinates to the system where the GIS Database converts the coordinates to the appropriate City/State using standard GIS methodologies. Once the coordinates have been converted to a City/State, the system forwards the request to the Tax Engine for the CTB calculation. When the CTB calculation has been completed, it is returned to the user's mobile device for display.

### Region Selection

Correspondingly, there are three methods available for the user to specify one or more regions of interest. The first method is for the user to type in a desired region, such as a county or state, on a system presented “fill-in” form. For example, if the user were to type in Montgomery County, Pennsylvania as the region of interest, then the system would return a CTB for each LTA within Montgomery County, Pennsylvania. If the user were to type in Pennsylvania, then the system would return a CTB for each LTA within the state of Pennsylvania. When the regions of interest have been submitted by the user, the regions are transmitted from the user's browser to the system's Tax Engine for CTB calculation. When the CTB calculations have been completed, they are returned to the user's system for display via the browser.

The second method to specify a region of interest is for the user to select from a drop-down list of taxing authorities supplied by the system's Tax Database. The top level drop-down list contains an alphabetical listing of first tier taxing authorities (States) in the country. Selection of a second-tier State would accept that State as the user's region of interest and prompt for another selection if desired. Selection of a third tier State would present another drop-down list with each of the counties in the State. Selection of a county from the drop-down list would accept that county as the user's region of interest.

A third method is via geospatial display, where the user can select interactively one or more regions of interest via mouse click-and-drag, enabling the regions to be defined as a circle with its center at the location of the mouse click, with a radius defined by the extent to which the mouse is ‘dragged’.

For those selections made specifically by address or geographically, the system interprets the municipalities/counties encompassed by the user selection via the GIS database and forwards the results to the Tax Engine. All other selections are sent directly to the Tax Engine. The Tax Engine then determines the names of all the taxing authorities encompassed in the selection using data stored in the Tax Database. In this manner, the system knows what taxing authorities' equations to use.

### Comprehensive Tax Burden Calculation

The Tax Engine uses two pieces of information when performing any tax calculations: 1) a designated user PFP to access, and 2) the user-selected locations or regions of interest. The tags for this information are delivered to the Tax Engine via the CTB request from the user's browser, which may use conventional technology.

The Tax Engine sends the user's selected location or region request to the GIS Database to identify the second-tier taxing authorities (for locations within second-tier States) or third-tier taxing authorities (for locations within third-tier States) located within the user's request. Information about the identified taxing authorities is then sent back to the Tax Engine.

Location selections received from the user are preferably handled in the following manner prior to calculation of the CTB:

1. For requests containing an address, the request is forwarded to the GIS Database for determination of second-tier and third-tier taxing authorities having jurisdiction at the location. Information about the identified taxing authorities is then sent back to the Tax Engine.
Example: A user request contains the address of 460 Ridge Pike, Limerick, Pa. The GIS Database determines this address is located in the township of Limerick—a third-tier taxing authority. Limerick Township then is identified as the local taxing authority (LTA) and that value is returned to the Tax Engine. The Tax Engine proceeds to calculate the user-specific CTB for Limerick Township, Pennsylvania.

2. For requests containing GPS (latitude/longitude) data, the request is forwarded to the GIS Database for determination of second-tier and third-tier taxing authorities having jurisdiction at the location. Information about the identified taxing authorities is then sent back to the Tax Engine.

3. For requests containing a specific borough/township (third-tier States) or county (second-tier States), no action is required to determine the taxing authorities. The Tax Engine proceeds to calculate the CTB.
Example: A user request contains the specific township name of Limerick, Pa. The Tax Engine verifies with the Tax Database that Limerick is an LTA within the State of Pennsylvania. The Tax Engine proceeds to calculate the user-specific CTB for Limerick Township, Pennsylvania.

Similarly, regional selections received from the user are handled in the following manner prior to calculation of the CTB:

1. For regional requests containing the name of a specific State or two or more counties (for second-tier States), or the name of a State, or one or more townships/boroughs (for third-tier States), no action is required to determine the taxing authorities. The Tax Engine proceeds to calculate the user-specific CTBs.
Example: A user request contains the region of the State of Pennsylvania. The Tax Engine proceeds to calculate the user-specific CTB for each of the 2,500+ boroughs, townships, and cities within the 67 counties in Pennsylvania.

2. For regional requests defined by a user-defined circle—the location and radius of the circle is forwarded to the GIS Database for determination of the LTAs (counties for second-tier States, or boroughs/townships for third-tier States) having jurisdiction in the region.

Once the LTAs have been identified, the information is sent back to the Tax Engine to begin calculation of the CTBs. The system calculates one CTB for each LTA contained in the user's request.

The Tax Engine accesses the tax equations for the first LTA and commences the tax calculations for that taxing authority, then moving through the equations for each of the higher tier taxing authorities having jurisdiction within the LTA. For example, assuming the LTA is the Borough of Trappe in Montgomery County Pennsylvania, the System determines from the Tax Database that the higher tier taxing authorities having taxing jurisdiction within Trappe are Perkiomen Valley School District, Montgomery County, and the State of Pennsylvania. Using as input the user's PFP, the Tax Engine calculates the user's CTB within the borough of Trappe using the algorithms for each of the four taxing authorities above as follows:

User's Trappe Borough Taxes+User's Perkiomen School District Taxes+User's Montgomery County Taxes+User's Pennsylvania Taxes=User's CTB for the geographical area within Trappe Borough

Expanding on the example above, assume the sample family described in the Income section above. Assume also that the user submits a CTB request for a location within the LTA of Trappe Borough in Pennsylvania. Using a sample of the actual tax algorithms, the user's CTB for the geographical area of Trappe Borough is calculated by the Tax Engine as follows:

User's Trappe Borough Taxes

| | |
|---|---|
| Earned Income (1% × $70,000) | $700 |

User's Perkiomen School District Taxes

| | |
|---|---|
| Real Estate Tax (28.14 mils $200k home) | $3,163 |
| Per Capita Tax (2 adults × $10 ea.) | $20 |

User's Montgomery County Taxes

| | |
|---|---|
| Real Estate Tax (2.695 mils $200k home) | $303 |

User's Pennsylvania Taxes

| | |
|---|---|
| Earned Income (3.07% × $70,000) | $2,149 |
| User's CTB for Trappe Borough = | $6,335 |

In a slightly different example, assume the same user has instead submitted a regional CTB request containing the counties of Berks, Chester, and Montgomery in Pennsylvania. These three counties comprise a total of 208 LTA's (boroughs, townships, and/or cities), each of which require a CTB calculation. Each calculation is done following the same methodology as shown in the simple example above. The calculations result in a minimum CTB value for the user-selected region of $4,408 for the LTA of Upper Merion Township, Montgomery County, and a maximum CTB value of $9,469 for the LTA of the City of Reading, Berks County. This would result in a difference to the user of $5,061 per year should they choose to live in one LTA over the other.

Berks County
Max CTB: $9,469 (City of Reading)
Min CTB: $6,464 (New Morgan Boro)

Chester County
Max CTB: $8,343 (City of Coatesville)
Min CTB: $4,447 (Tredyffrin Township)

Montgomery County
Max CTB: $8,630 (Cheltenham Township)
Min CTB: $4,408 (Upper Merion Township)

The tax equations used in the calculation of the user's CTBs are conditional, based upon data contained in the user's PFP. The tax engine skips the equations which are not relevant for the user (based upon the data in the user's PFP), and calculates using the equations which are relevant for the user based upon the data in the user's PFP. For example, active duty military in Pennsylvania do not have to pay the State income tax of 3.07% on their active duty pay, but active duty military in Virginia do have to pay the variable State income tax of up to 5.75% on their active duty pay. In this manner, any time the system comes across a tax type of “Income—Military Active Duty” in a tax equation, and the user has an income source of “Income—Active Duty Military” listed in their PFP, the system calculates the appropriate tax. A query is then generated to establish not only the current or intended legal residence, but also whether the user has any active duty military income.

When executing a tax calculation, the tax engine uses the user's data and the associated tax rate, as specified in the tax database. The calculated tax value is stored temporarily while awaiting succeeding calculations. Any subsequent tax values are added to the temporary value. Once tax calculations are done for the lowest level taxing authority, the tax engine checks the tax database for higher level taxing authorities whose jurisdictions fall within the lowest level taxing authority. For instance, once the tax engine completes calculations of a user's tax at a township level, it then proceeds to calculate the taxes from the appropriate school district, county, and state, adding each of the taxes to the temporarily stored tax value. When all of the user's taxes have been calculated at all levels of taxing jurisdictions, then the temporary tax value is stored in the user's PFP as the CTB value associated with the geographical jurisdiction of that lowest level taxing authority. Then the Tax Engine begins the process all over again for the next LTA in the user's CTB request. This process continues until CTBs have been calculated for all of the LTAs in the user's request. Once completed, the user's request is then forwarded to the Analyzer for further processing.

### Analysis and Display

Once the CTB calculations have been completed and stored by the Tax Engine, the user's request is forwarded to the Analyzer for analysis and rank-ordering of the data. If the user's request contained only one CTB value, no ranking analysis is required, and the CTB value and the taxes that comprise that value are sent to the Display Engine for display to the user. In the instance where the user's request requires the calculation of multiple CTB values, the data is rank-ordered and assigned colors prior to delivery to the Display Engine. The rank-ordering and color assignments are determined as follows:

The Analyzer determines the range between the highest and the lowest CTB values, this range then being divided into a system-determined number of equal sub-ranges (10 sub-ranges are used for this example), thereby creating a sub-range for those CTB values that fall within the lowest sub-range (or, for purposes of this example, the lowest 10% of the range between the highest and lowest CTB values), the next highest sub-range, and so on, up to those that fall within the top sub-range (or, for purposes of this example, the highest 10% of the range between the highest and lowest values). As an example, for a CTBₘₐₓ value of 4,000, and a CTBₘᵢₙ value of 2,000, the range is 2,000 (CTBₘₐₓ−CTBₘᵢₙ). Dividing the range by 10 yields 10 sub-ranges of 200 each [(CTBₘₐₓ−CTBₘᵢₙ)/10]. Any CTB values that fall in the sub-range of 2,000-2,200 would therefore be considered the lowest 10% of all the CTB values in the user's current selection. The system assigns a unique color to each sub-range such that, any Comprehensive Tax Burden values falling within the lowest sub-range would be assigned color 1, those falling within the next highest sub-range would be assigned color 2, and so on until a unique color has been assigned to all values in all sub-ranges.

The Analyzer then stores the color codes, along with the corresponding CTB values, in the Comprehensive Tax Burden Database, and forwards the Rank-ordered Comprehensive Tax Burdens (that is, the values, the rankings, and the corresponding colors) to the Display Engine.

The Display Engine formats the CTB values, rankings, and colors in preparation for display to the user. The Display Engine provides the following display options to the user:
1) Tabular
2) Geospatial

The user is permitted to switch between either of these display options at any time.

### Tabular Display

The tabular display generally includes, but is not limited to, the following columns of data for each CTB value:
LTA Name
LTA County
LTA State
CTB Value
CTB Ranking
CTB Color

As an example of a tabular display, Table 1 shows an abbreviated display using CTB values calculated for the sample family of four making $70,000 per year.

TABLE 1
Tabular Display Sorted by Ranking

| | | | | Rank- | |
|---|---|---|---|---|---|
| LTA | County | State | CTB | ing | Color |
| Upper | Montgomery | Pennsylvania | $4,408 | 1 | [Color 1] |
| Merion | | | | | |
| Twp | | | | | |
| Tredyffrin | Chester | Pennsylvania | $4,447 | 2 | [Color 1] |
| Twp | | | | | |
| Lower | Montgomery | Pennsylvania | $5,382 | 3 | [Color 2] |
| Merion | | | | | |
| Twp | | | | | |
| Warwick | Chester | Pennsylvania | $5,908 | 4 | [Color 3] |
| Twp | | | | | |
| New Morgan | Berks | Pennsylvania | $6,464 | 5 | [Color 5] |
| Boro | | | | | |
| Pike Twp | Berks | Pennsylvania | $7,290 | 6 | [Color 6] |
| Parkesburg | Chester | Pennsylvania | $7,635 | 7 | [Color 7] |
| Boro | | | | | |
| Coatesville | Chester | Pennsylvania | $8,343 | 8 | [Color 8] |
| Cheltenham | Montgomery | Pennsylvania | $8,735 | 9 | [Color 9] |
| Twp | | | | | |
| Reading | Berks | Pennsylvania | $9,469 | 10 | [Color 10] |
| Boro | | | | | |

The user may choose a sorted view based upon any of the columns. A sorted view based upon the County column redisplays the data in the manner of Table 2.

TABLE 2
Tabular Display Sorted by County

| | | | | Rank- | |
|---|---|---|---|---|---|
| LTA | County | State | CTB | ing | Color |
| New Morgan | Berks | Pennsylvania | $6,464 | 5 | [Color 5] |
| Boro | | | | | |
| Pike Twp | Berks | Pennsylvania | $7,290 | 6 | [Color 6] |
| Reading | Berks | Pennsylvania | $9,469 | 10 | [Color 10] |
| Boro | | | | | |
| Tredyffrin | Chester | Pennsylvania | $4,447 | 2 | [Color 1] |
| Twp | | | | | |
| Warwick | Chester | Pennsylvania | $5,908 | 4 | [Color 3] |
| Twp | | | | | |
| Parkesburg | Chester | Pennsylvania | $7,635 | 7 | [Color 7] |
| Boro | | | | | |
| Coatesville | Chester | Pennsylvania | $8,343 | 8 | [Color 8] |
| Upper | Montgomery | Pennsylvania | $4,408 | 1 | [Color 1] |
| Merion | | | | | |
| Twp | | | | | |
| Lower | Montgomery | Pennsylvania | $5,382 | 3 | [Color 2] |
| Merion | | | | | |
| Twp | | | | | |
| Cheltenham | Montgomery | Pennsylvania | $8,735 | 9 | [Color 9] |
| Twp | | | | | |

The user may make selections from this table by positioning their cursor over one of the data cells and selecting the data cell with a mouse click. Selecting one of the LTAs causes a geospatial map to be displayed with an overlay of the geographical area defined by the LTA in the color assigned to the CTB. Selecting one of the Counties or States causes a geospatial map to be displayed with an overlay of the LTAs in the County or State displayed geographically. Each LTA region is shaded in the color assigned to its CTB value. Selecting one of the CTB values in this table causes a display to be generated showing the specific tax and tax amount for each of the taxes comprising a CTB. For instance, if the user selects the $8,735 CTB value for Cheltenham Township, the following information is displayed:

Your Comprehensive Tax Burden of $8,735 in Cheltenham Township, Pennsylvania is comprised of the following estimated taxes:

Cheltenham Township

| | |
|---|---|
| Earned Income | $350 |
| Property | $803 |
| Local Services Tax | $94 |

Cheltenham Township School District

| | |
|---|---|
| Earned Income | $350 |
| Property | $4,676 |
| Local Services Tax | $10 |

Montgomery County

| | |
|---|---|
| Property | $303 |

Pennsylvania

| | |
|---|---|
| Earned Income | $2,149 |
| TOTAL | $8,735 |

### Geospatial Display

The system preferably accesses normalized mapping data in order to display the CTB data geospatially. Basic mapping data may be received from mapping servers via the Internet and allows the user to see and manipulate standard maps such as one would find on Mapquest, or Google/Bing Maps. Additionally, upon receipt of the user's request from the Analyzer, another layer (or shape file) is generated and added by the Display Engine for every regional CTB request. This allows the user to see geospatially all of the data calculated by the Tax Engine and rank-ordered by the Analyzer. The generation of the shape file preferably uses conventional industry software tools. The system, however, generates a user-specific shape file for displaying user-specific CTB information.

Generation of the user-specific shape file includes not only the jurisdictional boundaries for LTAs, but the geographical tax units are also shaded with the color corresponding to the user's CTB calculated for each LTA. Using the example from above, the geographical tax unit encompassed by Cheltenham Township is shaded with color 9, denoting its standing in the top 20% of highest CTBs for the specified user. The user-specific generated shape file is stored in the GIS Database.

After accessing the Internet map servers for the basic map view called by the user's system, the Display Engine accesses the internal GIS Database for the user-specific shape file. This layer is overlaid on the map from the Internet map servers.

Additionally, at the appropriate map extent (or zoom level), the ranking and CTB for each LTA are displayed centrally over each corresponding LTA. In this manner, the user is able to quickly see at a glance through the color scheme how the CTB for each LTA compares generally to those surrounding it. As the user zooms in, he is able to see more specifically how CTBs compare through the displayed ranking and the actual CTB values. Selecting any of the CTB values via a mouse click displays the specific taxes comprising the CTB, as also shown in the Tables 1 and 2.

Normal mapping tools may be available to the user while viewing the geospatial display. These include, but are not limited to, displaying streets, pan, zoom, and adjusting transparency level.

Although the present invention has been described in particular detail with respect to certain embodiments, those skilled in the art will appreciate that the invention may be practiced in other embodiments. First, the particular naming of the features, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions described as being performed by a single system component may instead by performed by multiple components, and functions describing as being performed by multiple components may instead be performed by a single component.

Some portions of the above description present features of the present invention in terms of equations and symbolic representations of operations on information. These mathematical descriptions and representations are used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission, or display devices.

Certain aspects of the present invention include process steps and instructions described herein in the form of an equation. It should be noted that the process steps and instructions of the present invention may be embodied in software, firmware, or hardware, and when embodied in software, may be downloaded to reside on and be operated from different platforms used by real time network operating systems.

The present invention also relates to an apparatus for performing the operations described herein. This apparatus may be specially constructed for the required purposes, or it may include a general-purpose computer selectively activated or reconfigured by a computer program stored in the computer. Such a computer program may be stored on a computer-readable storage medium, including, but not limited to, any type of disk including floppy disks, optical disks, compact disc read-only memories (CD-ROMs), magnetic-optical disks, read-only memories (ROMs), random access memories (RAMs), erasable programmable read only memories (EPROMs), electrically erasable programmable read-only memories (EEPROMs), magnetic cards, optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general purpose systems may also be used with programs in accordance with the teachings herein, or it may prove convenient to construct more specialized apparatus to perform the required method steps. The structure for a variety of these systems appears from the description below. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks include storage devices and computers that are communicatively coupled to dissimilar computers and storage devices over a network, such as the internet.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method of determining a plurality of comprehensive tax burdens in a plurality of geographical tax units for a taxable entity, the method comprising the steps of:
a) maintaining a tax rate database for tax rates associated with the plurality of geographical tax units;
b) acquiring a taxable entity financial profile for the taxable entity;
c) calculating the comprehensive tax burden for each of the plurality of geographical tax units by applying data from the taxable entity financial profile to data from the tax database for each of the plurality geographical tax units; and
d) presenting each comprehensive tax burden for each of the plurality of geographical tax units.

2. The method of claim 1, wherein the taxable entity is an entity selected from the group consisting of: an individual person, a family, and a business.

3. The method of claim 1, wherein step a) comprises the sub-steps of:
querying at least one internet database for updates to tax rates in the tax rate database; and
updating the tax rate database with updates to the tax rates from the internet database.

4. The method of claim 1, wherein step b) comprises the substep of querying a user for information for the taxable entity financial profile.

5. The method of claim 4, wherein the taxable entity financial profile comprises
information selected from the group consisting of: earned income, investment income, property owned, value of property owned, consumer spending habits and amounts, job location, retirement assets, and age for the taxable entity.

6. The method of claim 1, wherein the taxes in the tax rate database comprise at least one tax selected from the group consisting of: local income taxes, county income taxes, state income taxes, local property taxes, school property taxes, sales taxes, and gas taxes.

7. The method of claim 1, wherein the geographical tax units are selected based on information supplied by a user.

8. The method of claim 1, wherein step d) comprises the sub-step of presenting the comprehensive tax burdens in a rank-ordered tabular form for each geographical tax unit.

9. The method of claim 1, wherein step d) comprises the sub-steps of:
assigning a color to each comprehensive tax burden based on a relative value of the comprehensive tax burden; and
presenting a map showing each geographical tax unit shaded with the color assigned to the geographical tax unit based on the comprehensive tax burden.

10. The method of claim 1, wherein step d) comprises the sub-steps of:
assigning a ranking to each comprehensive tax burden based on a relative value of the comprehensive tax burden; and
presenting a map showing each geographical tax unit shaded with the ranking assigned to the geographical tax unit based on the comprehensive tax burden.

11. A computer-implemented method of presenting a plurality of comprehensive tax burdens in a plurality of geographical tax units for a taxable entity, the method comprising the steps of:
a) calculating the comprehensive tax burden for each of the plurality of geographical tax units by applying data from a taxable entity financial profile to data from a tax database for each of the plurality geographical tax units;
b) comparing the comprehensive tax burdens to determine a rank order of the comprehensive tax burdens; and
c) presenting the comprehensive tax burdens based on the rank order.

12. A computer-implemented method of transforming data in a tax rate database into a comprehensive tax burden comprising the steps of:
a) maintaining the tax rate database for tax rates for at least one geographical tax unit; and
b) applying a taxable entity financial profile to the tax rate database to calculate a comprehensive tax burden for the geographical tax unit.
